(19) United States
(12) Patent Application Publication
(10) Pub. No.: US 2015/0172739 A1
(43) Pub. Date: Jun. 18, 2015

(54) DEVICE AUTHENTICATION

(71) Applicant: Strategy and Technology Limited, London (GB)

(72) Inventor: David Shaw, Yorkshire (GB)

(21) Appl. No.: 14/629,263

(22) Filed: Feb. 23, 2015

Related U.S. Application Data
(63) Continuation of application No. PCT/EP2013/067419, filed on Aug. 21, 2013.

(30) Foreign Application Priority Data
Aug. 21, 2012 (GB) 1214906.8
Sep. 13, 2012 (GB) 1216386.1
Nov. 19, 2012 (GB) 1220793.2

(51) Int. Cl. H04N 21/418; H04N 21/258

(52) U.S. Cl. CPC H04N 21/4181; H04N 21/25816

(57) ABSTRACT

A method, system and corresponding components to authenticate a host device are disclosed. In one aspect, an established process for coupling a module and a host device is used, the established process allowing the host device and module to mutually authenticate each other. A third entity, an authentication server, is then used to authenticate the module using an identification stored in the module such as a private key, or other ID information. By virtue of remotely authenticating the module, and the mutual authentication between the module and the host device, the authentication server is able to trust the host device and proceed to a next step, such as providing access rights to the host device to access content.

### RELATED APPLICATIONS

This application claims priority to International Application No. PCT/EP2013/067419, filed on Aug. 21, 2013, British Patent Application No. GB 1214906.8, filed on Aug. 21, 2012, British Patent Application No. GB 1216386.1, filed Sep. 13, 2012, and British Patent Application No. GB 1220793.2, filed Nov. 19, 2012, each entitled “DEVICE AUTHENTICATION,” which are incorporated herein by reference in their entirety.

### BACKGROUND

1. Field

The disclosed technology relates to a method and apparatus for authenticating a device, and particularly to authenticating a device using the properties of standards such as the CI-Plus or CableCARD standards.

2. Description of the Related Technology

The Digital Video Broadcast (DVB) Common Interface (CI) specifications EN 50221 and TS 101699, describe a framework that utilizes a removable Conditional Access Module (CAM). The CAM, which contains the appropriate access rights, receives protected content from the Host device, unscrambles the protected content and passes it back to the Host over the same interface. The Common Interface connector is an industry standard Personal Computer Memory Card International Association (PCMCIA) slot. As a result, descrambled content is passed over a “standard” interface without any protection.

The “CI-Plus” standard, for example as defined in specification v1.3.1, defines a standardized interface between the Host (e.g., a TV) and pluggable Module which implements the Conditional Access, allowing multiple Conditional Access solutions to interoperate with a single Host. The CI-Plus Controlling Entity, CI Plus LLP, issues licenses for implementations that include compliance and robustness rules ensuring a device is fit for purpose. This is backed up by a Trust Authority and Certificate Authority which provide the Certificates required by the device to allow it to interoperate with other certified devices.

FIG. 1 shows a general overview of a CI-Plus system. CI-Plus defines the Content Control (CC) System which supports mutual authentication between Host and Module. The Host and Module exchange certificates and each confirms the authenticity of the certificate, and therefore the authenticity of the Host or Module device, by verifying the certificate's digital signature.

Interactive Middleware Applications operating on the receiver side control the presentation of on screen graphics, video and audio and react to user input. They can provide access to video and audio from broadcast or from the internet. Generally, when Interactive Middleware Applications, such as an MHEG application, are used to deliver content such as movies on demand, they are required by the content rights owners to employ a DRM system to protect the content. This usually involves device authentication coupled with some form of content encryption. We have appreciated that a method of device authentication of the sort used in the CI-Plus method, and other compatible or similar standards between module and host devices, could be used to enhance existing delivery systems that encrypt content but do not include device authentication. An example of such a delivery system includes the MHEG Interaction Channel defined by the European Telecommunications Standards Institute MHEG standard, such as the ETSIMHEG document ES 202184 v2.2.1. The MHEG Interaction Channel is an extension to the MHEG standard allowing access to static and streamed content over the internet using HTTP protocols. The MHEG Interaction Channel (MHEG-IC) enables an extension to broadcast services to be delivered via an IP connection; for example, the MHEG-IC can access content (applications, text, graphics and streaming media) from either the broadcast network or the IP connection.

We have appreciated that the mutual authentication performed between a host device and a removable module according to standards, such as the CI Plus standard, can be used to provide authentication of a host device running an interactive application for delivering a service to the user. Although embodiments of the invention were developed in relation to the CI Plus standard, it has been appreciated that other standards or protocols that provide for similar mutual authentication, such as the CableCARD standard, may be equally suitable for use in implementing embodiments of the invention.

### SUMMARY OF CERTAIN INVENTIVE ASPECTS

The invention is defined in the claims, to which reference is now directed. Preferred features are set out in the dependent claims.

Embodiments of the invention provide a method, system and corresponding components to authenticate a host device. An established process for coupling a module and a host device is used, the established process allowing the host device and module to mutually authenticate each other. A third entity, an authentication server, is then used to authenticate the module using an identification or credentials stored in the module such as a private key, certificate or other ID information. By virtue of remotely authenticating the module, and the mutual authentication between the module and the host device, the authentication server is able to trust the host device and proceed to a next step, such as providing access rights to the host device to access content.

Embodiments of the invention may provide a method for authenticating a host device in a television receiver system for providing media content to a user. The system comprises a host device to be authenticated and a removable authentication module coupled to the host by an interface. The host device is configured to receive media content via broadcast and/or via the internet. The removable authentication module and the host are configured to communicate over the interface and to perform mutual authentication of one another according to a particular protocol or standard. At least one of the host device and the removable authentication module are configured to communicate with an authentication server, via an internet connection for example. The method comprises issuing a request to the authentication server to perform authentication of the authentication module and then performing authentication of the authentication module. Authentication is achieved by exchanging data between the authentication server and the authentication module, either by connection between the server and the module, or by exchanging data between the authentication server and the authentication module via the host device. The host device is deemed to be authenticated when the authentication module and host are successfully mutually authenticated and the authentication module is successfully authenticated by the authentication server.

Performing authentication in this manner allows the host to be trusted by the authentication server by virtue of the authentication server trusting the removable module, and by virtue of the authentication between the host and the removable module. The invention uses a system that already provides mutual authentication between the host and a removable module to ensure that the authentication server can trust the host. Successful authentication means that the host device can be confirmed to be operating in the manner expected, correctly operating according to the particular protocol, allowing the module and the authentication server to trust the host device.

The mutual authentication between the host and the authentication module may be performed according to an existing standard. The host and authentication module may be coupled, and communicate, according to the Common Interface (CI) Plus standard, such as the CI-Plus standard as defined in CI Plus Specification v1.3.1 (2011-09).

The host device may also be configured to execute one or more applications, including interactive applications to control the presentation of on screen graphics, video and audio and react to user input. The application may specifically be an MHEG application and an MHEG interaction channel compliant application. An Application Man Machine Interface resource may optionally be used to send and receive data between the host and the authentication module. Alternatively the interactive application may be a Hybrid Broadcast Broadband TV (HbbTV) application or a Multimedia Home Platform (MHP) application and a Specific Application Support Resource may optionally be used to send and receive data between the host and the authentication module. The method may further comprise sending a request from the authentication module to commence operation of the interactive application. Alternatively, the interactive application may already be running on the host device, in which case the method further comprises sending a request from the authentication module to grant access to the authentication module by the interactive application. The application may communicate with the authentication module via an API. The application may be delivered to the host via a broadcast.

After authentication between the module and host is performed, authentication between the module and the authentication server is performed. This requires communication between the module and the authentication server in order to exchange authentication data. In some embodiments communication can occur via the host device, although it is possible for this communication to bypass the host device.

In some embodiments authentication of the authentication module by the authentication server may be performed using a communication resource on the host device. This communication resource provides the module with access to a connection that it can use to communicate with the authentication server, such as an internet connection or mobile network connection. In particular, a low speed communication resource on the host device may be used.

Authentication of the authentication module by the authentication server may comprise the use of TLS between the module and the server, or a similar bespoke system. For example, the authentication may comprise digitally signing authentication data at the authentication module and sending the signed authentication data from the authentication module to the authentication server via the host and verifying the signature created by the authentication module. In some embodiments, the authentication data may be originally received at the host before being sent to the authentication module for signing.

In some embodiments, an interactive application executing on the host may be used in the exchange of data, with the interactive application receiving the authentication data, sending it to the authentication module and forwarding the signed authentication data from the module to the authentication server. The interactive application may issue the request to the authentication server to perform authentication of the authentication module, and authentication of the authentication module may be performed by exchanging data between the authentication server and the authentication module via the interactive application executing on the host device. In some examples, such as those where the module has direct access to a communication resource on the host, authentication does not require the participation of the interactive application.

The authentication of the module by the server may be performed using established techniques such as TLS or other suitable schemes. Digitally signing the authentication data may be performed using a private key stored on the authentication module, and may further comprise, at the authentication module, combining the signed authentication data with authentication module identification information or credentials that uniquely identifies the authentication module and/or private key identification information that uniquely identifies the private key. The authentication server may then verify the authentication module using a public key associated with the authentication module. The authentication information or credentials of the module may be issued by a Certificate Authority.

For embodiments that use the AppMMI resource, the Interactive Middleware Application may acquire some arbitrary data from the Authentication Server, or other source such as via broadcast, and send this to the Module via the AppMMI resource. The Module returns a digital signature, which is the data plus Module and/or private key identification information signed by the embedded private key. The Interactive Middleware Application returns this digital signature to the Authentication Server where it can be verified using the appropriate paired public key, which is located on, or accessible by, the Authentication Server. The verification of this digital signature provides a guarantee to the Authentication Server that the Interactive Middleware Application is executing on a Host that is compliant with the CI-Plus standard, and thus verifies that the Host complies with the requirements to receive the service(s) provided by the Interactive Middleware Application.

Once authentication of the authentication module by the authentication server is complete a verification signal may be issued by the authentication server or other appropriate remote server indicating that the authentication server trusts the authentication module. The verification signal may be in the form of a token permitting access to certain content from a content server.

Certain embodiments of the invention may therefore provide a mechanism for providing device authentication utilizing an Interactive TV Middleware Application, the CI-Plus Application Man Machine Interface (AppMMI) resource, and any suitable authentication scheme between the module and the authentication server, such as a private key embedded in a CI-Plus Module and a paired public key located on an Authentication Server. Embodiments may use a communication resource on the host device, such as a low speed communications resource, and a content control resource, in combination with any suitable authentication scheme, including TLS.

According to certain embodiments the host device may store signed authentication data in a store of the host device. The store may comprise a persistent store. An interactive application may cause the storing of the signed authentication data. An interactive application may read the store to acquire signed authentication data. In this way, the signed authentication data may be retrieved by other interactive applications. An interactive application may send the signed authentication data to the authentication server to verify the signature was created by the authentication module. The interactive application or applications may be stored on the authentication module. The interactive application or applications may be delivered via a broadcast.

Embodiments of the invention may also offer service providers the ability to upgrade both Module software and hardware in the event that the security is compromised. If the public/private keys/credentials are compromised the Module can be replaced or its software updated by either a broadcast over air download, over the internet, or other proprietary mechanism. In addition, embodiments may support revocation of Module or Host devices, either via the CI-Plus Certificate Authority or by revoking a private key or credentials embedded in the Module.

According to embodiments of the invention, data may be passed from the authentication module to the host using one or more components of a transport stream. In embodiments data may be passed from the authentication module to the host using an object carousel insertion method. The method may further comprise inserting the data into an existing object carousel, generating a new object carousel containing the data at the authentication module or receiving an object carousel containing the data at the authentication module from a remote source such as the authentication server. The method may further comprise receiving a transport stream at the authentication module, via the host, and inserting the object carousel into the transport stream. Alternatively the method may include generating a transport stream, containing the authentication data within the object carousel, at the authentication module using the Common Interface Input Module Resource. The host may execute an application to read the data from the transport stream and particularly from the object carousel, where this is used to send the data. The transport stream containing the object carousel may be scrambled, encrypted or encoded by the module according to the particular protocol/standard before being passed to the host and descrambled, decrypted or de-encoded as appropriate.

The data being transmitted in the carousel may be a token confirming access rights to content from a content server and/or authentication data. In particular, performing authentication of the authentication module may be performed by exchanging data between the authentication server and the authentication module by passing authentication data from the authentication module to the host, the authentication data being used by the authentication server in the authentication process. This authentication data, e.g., a digital signature, may be passed from the authentication module to the host within an object carousel. Alternatively, or in addition, a verification signal or token may be passed from the module to the host using the object carousel for subsequent use by the host or an application executing on the host.

Other methods for passing data between the module and host are possible. In some embodiments, performing authentication of the authentication module by exchanging data between the authentication server and the authentication module includes passing authentication data from the authentication module to the host, the authentication data being used by the authentication server in the authentication process, wherein the authentication data is passed from the authentication module to the host within a Program Map Table (PMT). The authentication data may be contained within a descriptor of a PMT. The method may use the Host Control Resource as described in the DVB CI Plus standard. The descriptor used may be the network_boot sub descriptor. Authentication data within the descriptor may be read by the host using the GetBootInfo resident program.

Providing device authentication in this way allows high value content to be delivered, such as premium movies, whilst minimizing the risk that the target device will leak this content.

Embodiments may provide a corresponding computer program which when executed on a host device and/or authentication module causes it to carry out the methods described herein.

Embodiments may also provide a television receiver system for use in authenticating a host device. The system comprises a host device to be authenticated, the host device being configured to receive media content via broadcast and/or via the internet. The host device has a processor that may be configured to execute an application for providing media content to a user. The system further comprises a removable authentication module coupled to the host by an interface, the host and authentication module being configured to communicate over the interface and to perform mutual authentication over the interface according to a particular protocol/standard. At least one of the authentication module and the host device has a communication module to allow communication with an authentication server. The host or the module is configured to issue a request to the authentication server, using the communication module, to perform authentication of the authentication module, in response to which authentication of the authentication module is performed by the authentication server. The host device is deemed to be authenticated when the authentication module and host are successfully mutually authenticated and the authentication module is successfully authenticated by the authentication server.

The host device may comprise the communication module, such as an HTTP stack accessible by the application executing on the host. Alternatively, the communication module may comprise a communication resource such as a low speed communication resource located on the host device.

Performing authentication of the authentication module may comprise exchanging data between the authentication server and the authentication module via the host device using cryptographic techniques such as TLS.

The authentication module may be configured to pass data to the host using one or more components of a transport stream such as an object carousel. In particular, the authentication module may be configured to insert the data into an existing object carousel, to generate a new object carousel containing the data or to receive a new object carousel containing the data at the authentication module from a remote source. The authentication module may be configured to receive a transport stream, via the host, and to insert the object carousel into the transport stream. The host may be configured to execute an application to read the data from the transport stream and particularly from the object carousel where this is used to send the data.

Embodiments may also provide an authentication module configured for use in the methods described herein, or for use in the systems described herein. The authentication module comprises an interface for communication with a host device, the module being configured to communicate with the host device over the interface and to perform mutual authentication over the interface according to a particular protocol. The module further comprises a memory having stored thereon module specific authentication credentials or secrets, and wherein the authentication module is configured to perform authentication by a remote authentication server such as by digitally signing authentication data using the module specific credentials. The module may further comprise a memory having stored thereon identification data uniquely identifying the module, the module being further configured to include the identification with, or within, the digital signature. The module itself may further comprise a communication module for communicating with an authentication server over a communication network such as the internet and/or a mobile network. The communication module may be a wireless communication module for wirelessly connecting to the internet or mobile network. The authentication module may be a conditional access module.

The host device may be a television receiver such as a set top box or similar device for receiving broadcast media content and/or for receiving content over the internet. In this manner, the television receiver may be considered to be a hybrid receiving device as it can receive content via broadcast and over a network such as the internet.

The host and authentication module may be coupled, and communicate, according to an existing standard such as the Common Interface (CI) Plus standard, or any other suitable standard protocol that provides mutual authentication. In the example using the CI-Plus standard, the mutual authentication of the host device and authentication device is performed in accordance with the CI-Plus standard. The CI-Plus standard may be as defined in CI Plus Specification v1.3.1 (2011-09).

The interactive application which may use the result of the authentication to request content from a content server may be configured to operate according to the MHEG standard, and implement the MHEG interaction channel.

Embodiments of the invention may provide a host device, removable authentication module and application server for use in the methods and systems described herein.

### BRIEF DESCRIPTION OF THE DRAWINGS

Examples of the invention will now be described in more detail with reference to the accompanying drawings.

FIG. 1 shows an overview of a known CI-Plus system.

FIG. 2 shows an overview of a system according to embodiments of the invention.

FIG. 3 shows the sequence of interactions between the Module, Host, Interactive Middleware Application and Authentication Server according to an embodiment of the invention.

FIG. 4 shows an overview of a system according to an embodiment of the invention.

FIG. 5 shows the sequence of interactions between the Module, Host and Authentication Server according to an embodiment of the invention.

FIG. 6 shows an overview of a system according to an embodiment of the invention.

FIG. 7 shows the sequence of interactions between the Module, Host and Authentication Server according to an embodiment of the invention.

FIG. 8 shows an overview of a system according to an embodiment of the invention.

FIG. 9 shows an overview of a system according to an embodiment of the invention.

### DETAILED DESCRIPTION OF CERTAIN ILLUSTRATIVE EMBODIMENTS

Several example embodiments will now be described. It will be appreciated that elements from one embodiment may be combined with one or more elements from the other embodiments as appropriate.

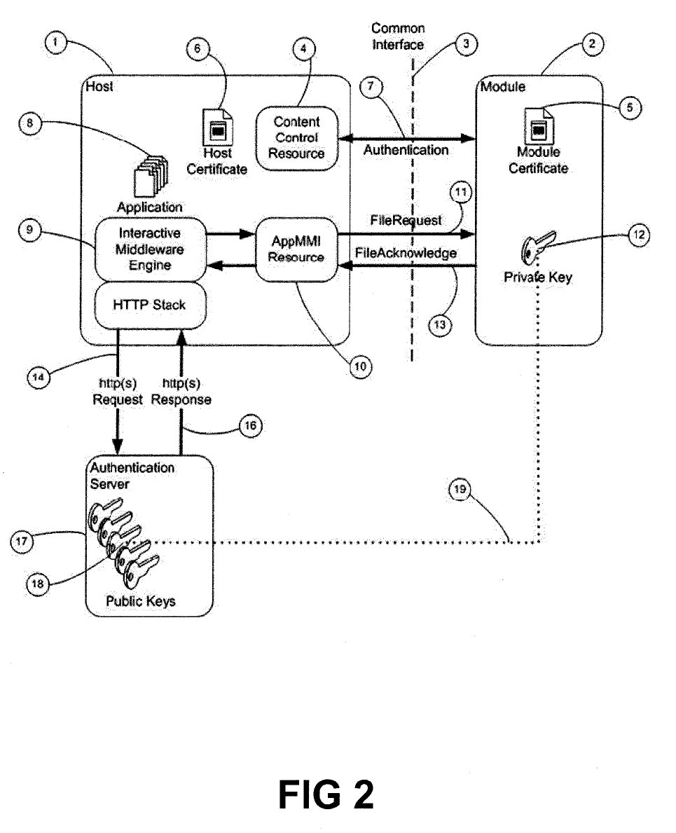

FIG. 2 shows the schematic overview of a Host device 1, which may be a user device such as an Integrated Digital TV or Set Top Box. A CI-Plus Module 2 is inserted into the Host's Common Interface 3, which may be a standard interface such as a PCMCIA slot. The Host and Module can mutually authenticate 7 each other via the Content Control Resource 4 and using certificates 5 and 6. In this example embodiment the Host and Module support the CI-Plus standard, and particularly the type of mutual authentication supported by the CI-Plus standard. Since this general mutual authentication method between the Host and the Module is described in the CI-Plus standard it will not be described in particular detail here.

The Host implements an Interactive Middleware Engine 9 which supports the execution of an Interactive Application, such as Interactive Middleware Application 8. The Interactive Middleware Engine, which may be a dedicated functional module or may be implemented as, or controlled by, software executing on a processor, communicates with the CI-Plus Application MMI Resource 10 allowing the Interactive Middleware Application 8 to issue file requests 11. The Module 2, also referred to as an Authentication Module, responds to these requests with file acknowledgements 13. Again, the general method and environment for the Application MMI is described in the DVB specification TS 101699 and the CI-Plus specification, for example, and will not be described in particular detail here.

According to the DVB specification, the concept of an Application Domain Man Machine Interface (MMI) is specified. The Application Domain MMI enables an unspecified presentation engine to be used, enabling customized CICAM (Common Interface Conditional Access Module) application presentation and interaction to be achieved in comparison with the conventional High Level Application MMI. The CI-Plus presentation engine enables the module to present information with the look and feel specified by the service operator rather than being constrained to the High Level MMI for which there is limited presentation control and interaction.

CI-Plus defines an Application Man Machine Interface (AppMMI) resource which allows an Interactive Middleware Application executing on the Host to request files from the Module and also send and receive data to and from the Module. Content may be supplied to the CI-Plus presentation engine directly from the CICAM through the AppMMI resource; the CICAM itself may optionally source file data internally from the CICAM and/or directly from the broadcast stream. The Middleware Application may also access content directly from a broadcast or over the internet, such as in cases where no conditional access rules are applied to the content. In some embodiments the Middleware Application may also read and write data from and to a Host storage device or Persistent Store which is available beyond the life cycle of the application.

The CI-Plus AppMMI Resource 10 supports “file” and “data” type file requests. The “file” type file request allows Interactive Middleware Application 8 to request files from the Module 2. The “data” type file requests allow the Interactive Middleware Application 8 to send data to the Module 2 and the Module to respond with data. The Module contains a private key 12 or a certificate, on a memory, which is used to sign data sent to it.

The Interactive Middleware Engine 9 includes a communication module which includes a communication protocol module, such as an HTTP stack, allowing the Interactive Middleware Application 8 to communicate with servers connected to the internet by issuing appropriate signals such as http or https requests 14. The servers respond with appropriate responses such as http or https responses 16.

An Authentication Server 17 is one such server with which the Interactive Middleware Application 8 is able to communicate. The Authentication Server 17 is connected to the internet and has access to a number of public keys 18. These public keys are paired with a number of private keys embedded in different authentication modules.

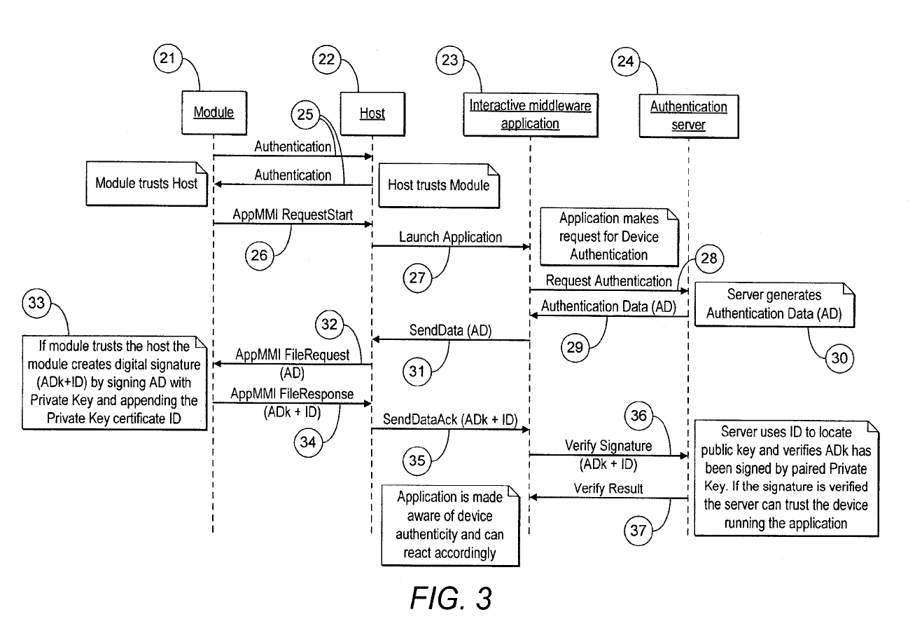

FIG. 3 shows the sequence of interactions between the system components shown in FIG. 2 which result in the Authentication Server being able to authenticate the Host Device with which it is communicating.

The Module 21 and Host 22 mutually authenticate each other 25 as defined by the CI-Plus standard. If authentication is successful the Module can allow communication with the Interactive Middleware Application to access the Module file system. In particular, the Module can signal to the Host that the Application MMI is ready for operation to allow communication between the Module and the Interactive Middleware Application. For some embodiments, the Module may initiate communication with the Application via the Application MMI. The Module may initiate the Interactive Middleware Application 23 by issuing an “AppMMI Request Start” message 26 to the Host such that the Host then launches the Application. Alternatively, the Module may grant access to an Application that is already running on the Host.

The Interactive Application may be initially stored on the Module and provided to the Host for execution once the Module is inserted into the Host's interface and the Host is switched on or activated. Alternatively, the Interactive Application may be delivered to the Host via broadcast or over the internet, or come pre-loaded onto the Host.

Once mutual authentication of the Module and Host has occurred, authentication between the Module and the Authentication Server occurs. This can be achieved in a number of different ways as described herein. In this specific example the Interactive Middleware Application, executing on the Host device 22, makes a request for device authentication 28 from the Authentication Server 24. Authentication data is provided to the Interactive Middleware Application 29 to allow a security signing operation to take place between the Authentication Module 21 and the Authentication Server 24. The Authentication Server may generate the authentication data 30 and return this to the Interactive Middleware Application 29. Alternatively, the authentication data may be generated or provided from another source, for example the authentication data could be delivered over a data channel in a broadcast e.g., as a broadcast delivered token. The authentication data may be any sort of arbitrary data, the purpose of which is to undergo authentication operations to establish whether the Module 21 is known to, and trusted by, the Authentication Server 24.

The Interactive Middleware Application may send the authentication data to the Host 31 and subsequently to the Module using the Data type file request 32. In particular, the Application 23 may send the data to the Module via the Application MMI resource 10.

If the Module 21 trusts the Host 22 by virtue of the authentication 25 then the Module 21 uses the authentication data to create a digital signature 33 by applying cryptographic techniques. The resulting digital signature may include a private key and/or Module identifier. The digital signature may be created, for example, by signing the authentication data and appending to, or combining with, the signature a private key identifier and/or Module identifier. Alternatively, the private key identifier and/or Module identifier may be appended to, or combined with, the authentication data prior to signing. The resulting signature may be returned to the Host 34, specifically to the Application MMI resource, and passed back to the Application 35. The Application then requests that the digital signature is verified, which may be achieved by sending the digital signature to the Authentication Server 36.

In some embodiments the Authentication Server may not need to possess the authentication data to confirm that the Module is authentic. There may, for example, be a scheme whereby the authentication data changes over time. As will be appreciated, the precise protocol for generating the digital signature and checking that the Module is authentic between the Module and the Authentication Server may vary and there are many methods of creating and authenticating digital signatures that may be suitable.

The Authentication Server may use the private key identifier or Module identifier in the digital signature to locate the paired public key. This public key is used to verify that the digital signature has been created by an authentic private key thus providing device authentication for the Module 21, and also the Host by virtue of the mutual authentication 25 between the Module and the Host. For example, the public key may be used to decrypt the authentication data, and the Authentication Server may then compare the decrypted authentication data with the original authentication data generated at step 30, with a match indicating that the private key pairs with the public key and thus the Module 21 can be trusted. The Authentication Server then returns the verification result to the Application 37, indicating to the Application that the Module has been verified as authentic by the Authentication Server 24. There are, as will be appreciated, numerous protocols that can be applied here. For example, the Module may generate a hash of the data then encrypt the result of this instead of the data itself. If the Authentication Server knows the hash used it can verify the encrypted hash. Optionally a random “salt” may be added to the data before hash/encryption.

The purpose of device authentication is to provide the Authentication Server with assurances that the device that it is communicating with is known to behave appropriately. For example, if the Authentication Server 24 authenticates the Module 21, it may provide access to content by the Host/application 22/23 by issuing a temporary “session token” with which the Interactive Middleware Application can make requests for content. If the Authentication Server is not satisfied with the device's authenticity it may issue an error code resulting in the Application presenting some failure information to the user.

In the event that security is compromised, embodiments of the invention may support revocation of Module or Host devices, such as via the CI-Plus Certificate Authority or by revoking a private key embedded in the Module. If the public/private keys are compromised the Module can be replaced or its software updated by either a broadcast over air download, over the internet or other proprietary mechanism. For example, data may be included in a broadcast that the Module or Host device can detect and extract in order to update the Module secret key. The DVB SSU standard provides a mechanism for updating digital TV software using the broadcast channel for delivery of software components that may be used. The module may detect and download any software targeted specifically to it.

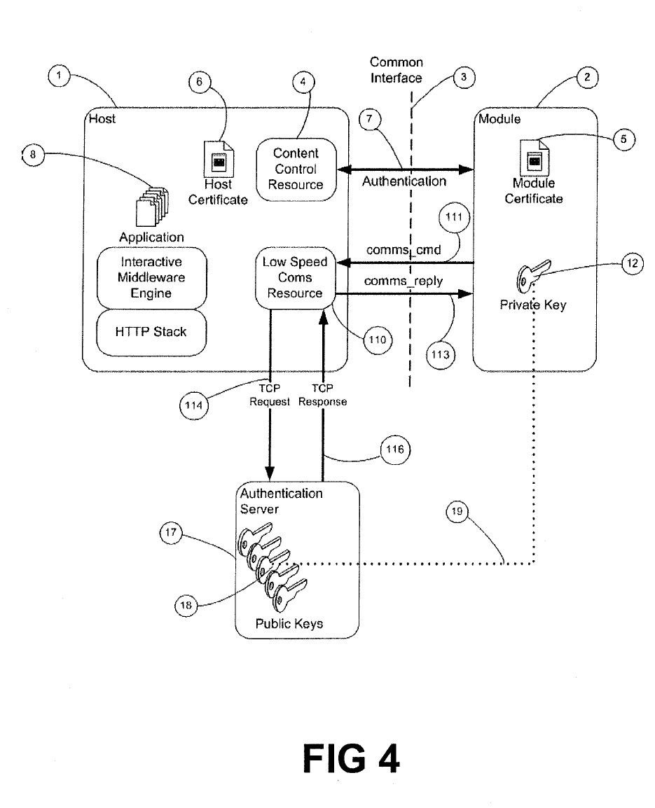

FIG. 4 shows an alternative embodiment of the invention in which common components and features with the embodiment of FIGS. 2 and 3 are given like references. In the authentication system of FIG. 4, the Host device 1 is configured to perform mutual authentication with the Authentication Module 2 in the same manner as described above. The primary difference with the embodiment of FIGS. 2 and 3 is the manner in which subsequent authentication between the Authentication Module 2 and the Authentication Server 17 takes place.

In the embodiments of FIGS. 2 and 3, the Interactive Application 8 operating on the Interactive Middleware Engine of the Host is responsible for sending and receiving files to/from the Module using the Application MMI Resource. This allows the Interactive Application to receive the signed authentication data and forward it to the Authentication Server. In contrast, the embodiment of FIG. 4 provides a communication link from the Module 2 to the Authentication Server 17 to allow authentication between the two components without requiring the participation of an Interactive Application or an Application MMI Resource. For the avoidance of doubt, however, the Application MMI Resource may still be present, although it is not shown in FIG. 4, and the interactive application may still be able to send and receive data to/from the Module.

The arrangement of FIG. 4 still provides a Host 1 that may implement an Interactive Middleware Engine supporting the execution of an Interactive Application, such as Interactive Middleware Application 8. However, in the arrangement of FIG. 4, a communication module 110 is provided that may not need to be coupled to, or be accessible by, the Interactive Middleware Engine. The communication module, which is the module that communicates with the Authentication Server, may provide a direct connection between the Authentication Module 2 and the Authentication Server 17. Communication module 110 may be provided in addition to or instead of the HTTP stack associated with the Interactive Middleware Engine, and they may share a physical connection.

In the arrangement of FIG. 4, the communication module may be a Low Speed Communication Resource (LSC) 110. An LSC is provided in the CI Plus specification, such as CI-Plus v1.3.1, which includes provision for “low speed” communication over IP connections for the purpose of supporting conditional access functions. The LSC may provide data to, and receive data from, the Authentication Server via the internet, using the TCP protocol for example. The term “low speed” is historical rather than indicative of the speed of connection that may be achieved. The LSC resource simply provides a connection that the Module can use to communicate with the Authentication Server.

The LSC 110 is operable to communicate with the Authentication Module using “comms_cmd” and “comms_reply” signals according to the CI Plus standard protocols. The LSC may receive authentication data from the Authentication Module and pass this on to the Authentication Server to perform a check to ensure that the Authentication Module is authentic. In response to determining that the Module is authentic, the Authentication Server may for example, as with earlier embodiments, issue a temporary “session token” to the host.

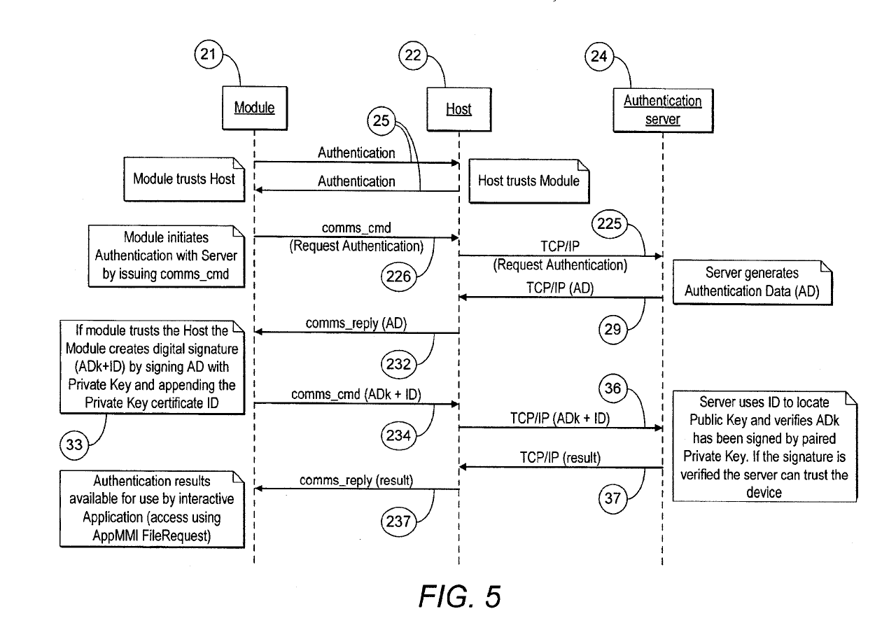

FIG. 5 shows an example of the sequence of interactions between the system components shown in FIG. 4 which result in the Authentication Server being able to authenticate the Host Device. Again, like components as shared with previous figures are given the same numbering.

The Module 21 and Host 22 mutually authenticate each other 25 in the same manner as described above, such as according to the CI-Plus or other suitable standard. The Module may initiate communication with the host using the LSC 110. Communication is achieved using suitable command messages such as the comms_cmd and comms_reply commands of the CI-Plus standard, which are sent from and received at the Module respectively. A comms_cmd 226 is sent to the host requesting authentication of the Module by the Authentication Server 24. The Host 22 communicates the request for authentication 225 to the Authentication Server. In embodiments utilizing the LSC this is achieved over the internet using TCP/IP communications containing the request.

When the Authentication Server 24 receives the request it generates the authentication data to be supplied to the Module 21. It will be appreciated, as with the other embodiments, that the Authentication Server need not generate the authentication data, since it may be generated elsewhere and delivered by another means such as via broadcast. However, as with the other embodiments, the Authentication Server 24 may generate the authentication data or trigger the generation or delivery of authentication data from elsewhere.

In those embodiments in which the Authentication Server generates the authentication data, it is passed back to the host over the TCP/IP connection as message 29 and is received at the LSC before being relayed back to the Module 21 as comms_reply 232 containing the authentication data.

If the Module trusts the Host, by virtue of the authentication 25, the Module uses the authentication data to create a digital signature 33 by applying cryptographic techniques, in much the same manner as described for earlier embodiments. The resulting digital signature may include a private key and/or Module identifier. A digital signature may be created, for example, by signing the authentication data and appending, or combining, the private key identification data/certificate ID and/or Module identifier data. The resulting signature may be returned to the Host 22 using an appropriate comms_cmd 234, and passed on to the Authentication Server 24 using the LSC.

The Authentication Server may use the private key identifier or Module identifier in the digital signature to locate the paired public key, in the same manner as described for above embodiments. In any case, if the signature is verified then the Authentication Server can trust the Module, and by extension can trust the Host. The result of the verification is passed back to the Host and onwards to the Module, which can make the authentication result available for use by the interactive application executing on the Host, such as by using an AppMMI file request of the sort described for the above embodiments or by passing data to the Host in any manner described herein. The authentication result may be, for example, a session token allowing the interactive application to access protected content or a protected service.

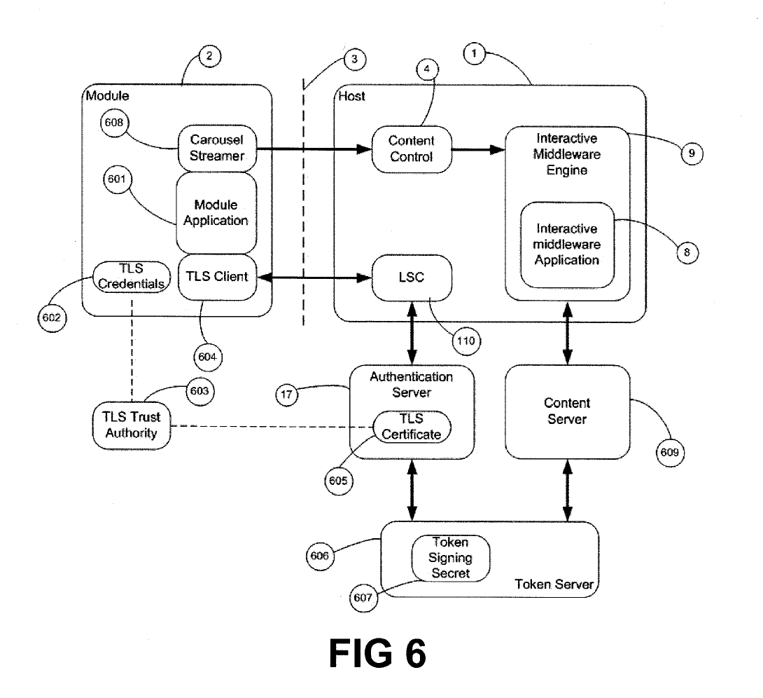

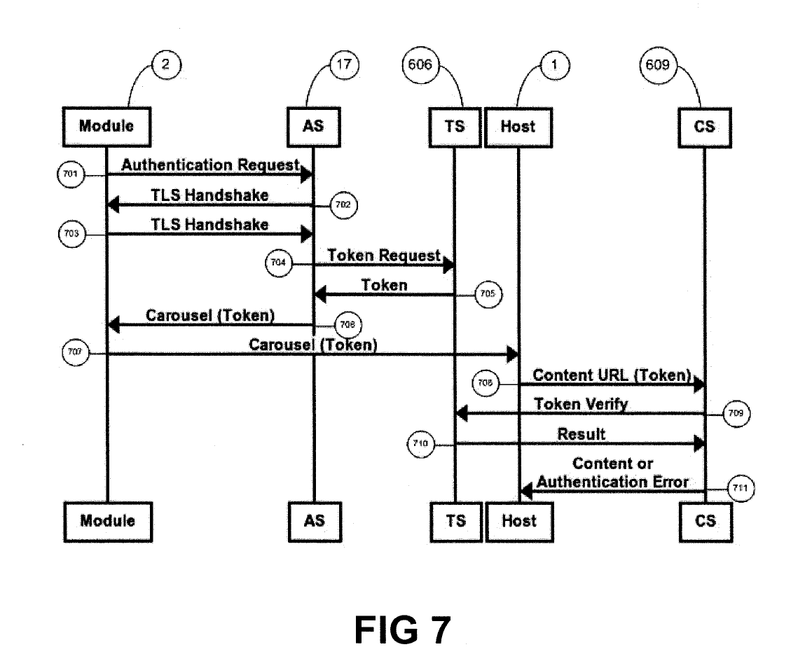

FIGS. 6 and 7 show a further example embodiment in which authentication of the Module and Host may be achieved using a client standardized authentication protocol such as Transport Layer Security (TLS) and/or Secure Socket Layer (SSL) for example as defined by IETF RFC 5246, including TLS v1.2, Broadcast File System replacement at the Module, the CI Plus Content Control Resource and Session Tokens.

TLS is implemented using transport layer protocols and provides a protocol for securing communications between applications over the internet. TLS secures application layer contents, such as web communications, and allows encryption of application data sent between a server and its clients, as well as providing authentication of both the server and the clients. SSL is the predecessor of TLS. The TLS and SSL protocols may be used in conjunction with HTTP as HTTPS, which is mentioned above and is used for secure internet transactions. The TLS/SSL protocols can also be used with other applications including file transfers.

Broadcast File Systems, such as DSM-CC Object Carousels, for example as defined by ISO/IEC 13818-6, provide a mechanism to deliver files to an Interactive Middleware Application over Broadcast Transport Streams. Replacing or modifying the Broadcast File System at the Module allows data specific to individual Modules to be carried in the replacement file system.

The Content Control is a CI Plus resource that provides Mutual Authentication between Module and Host and allows the Transport Stream that passes from Module to Host to be encrypted to prevent the interception of data passed across the interface.

Session Tokens in this example may be Module Specific data which have been cryptographically signed or encrypted and embedded in URLs issued by the Interactive Middleware Application to a Content Server as part of a content request.

FIG. 6 shows a Host 1 on which an Interactive Middleware Application 8 is operating. As shown in FIG. 6, the Interactive Middleware Application may be executed on a virtual machine such as an Interactive Middleware Engine 9, for example an MHEG virtual machine. The Host 1 may for example use the Interaction Channel, which, as described above, is an extension to the MHEG standard allowing access to static and streamed content over the internet using HTTP protocols and enables an extension to broadcast services to be delivered via an IP connection. The Host 1 receives content from a content server 609. A communication resource, such as Low Speed Communication Resource (LSC) 110 is used to provide connectivity with the Authentication Server, although any other type of communication link with the Authentication Server as described herein may be used.

The Module 2 and Authentication Server 17 may implement SSL/TLS, the Authentication Server may be configured to require client authentication and to request the Module's client credentials when the SSL/TLS session is established. The Authentication Server 17 can authenticate the Module's TLS Credentials 602 using the TLS certificate 605. As in the previous embodiment, upon authentication the server may issue a temporary and secure Session Token to the Module. The Interactive Middleware Application 8 acquires the token from the Module, using one of the methods described in previous or subsequent embodiments, and uses it in subsequent requests to the Content Server. The Content Server can verify the session token and is therefore assured that the Authentication Server trusts the Module, which in turn trusts the Host.

The Module 2 functions in a similar manner to the Modules described herein and may perform the mutual authentication as described. The Module may also include a Carousel Streamer 608, a Module Application 601, a TLS Client 604 and a stored set of credentials, such as TLS credentials 602, for use in authentication.

The Module Application 601 may be an embedded application executed on the Module. The responsibilities of the Module Application are: authenticating the Module with the Host; authenticating the Host device itself; authenticating the Module with the Authentication Server; and delivering authentication Session Tokens to the Interactive Middleware Application.

Whilst the type of authentication as between the Module and the Authentication Server can be as described above, this example is described with a specific method using TLS. The Module has embedded within it TLS credentials 602 issued by the TLS Trust Authority 603. Multiple features of the Module may be used in addition to ensure that the CI Plus and TLS credentials remain secret. For example, the Module Application may be verified by a secure boot loader.

The TLS Client 604 is a Module embedded software component that uses the Module's TLS credentials to provide client authentication and secure communications across the LSC resource 110. The Authentication Server 17 is a server side component which is responsible for authenticating the Module's TLS credentials. The Module makes requests to the server to authenticate itself using TLS Client Authentication. The server has installed a TLS Certificate 605 which is used to verify the Module's TLS credentials. Once it has authenticated the Module's TLS credentials, the Authentication Server requests a Module specific Session Token from the Token Server 606. The Session Token is returned to the Module as a response whether as a discreet file or embedded in an Object Carousel. The Token Server 606 generates and verifies Module specific Session Tokens. This can be achieved, as an example, by using a Token Signing Secret 607 and cryptographically secure algorithms, for example HMAC.

The Carousel Streamer 608 is a Module embedded software component that modifies the Broadcast Transport Stream as it passes through the Module. The Carousel Streamer replaces the Broadcast Object Carousel with an Object Carousel delivered to, or generated on, the Module. Alternatively the Carousel Streamer may modify an existing carousel within a transport stream. Carousel insertion techniques are described below in more detail.

Session Tokens are delivered to the Interactive Middleware Application using the Carousel Streamer which replaces the Object Carousel with one containing the Module's Session Token. Session Tokens may be embedded in request URLs sent from the Interactive Middleware Application to a Content Server 609 such that they can be authenticated with the Token Server.

FIG. 7 shows an example of the steps involved in authenticating the Module 2 of FIG. 6 and the acquisition of a token necessary to access the content or service being requested from the Content Server 609. The Module 2 initiates the request for a token with an authentication request 701 to the Authentication Server 17. This may involve a token request sent from the Module, followed by TLS handshakes 702 and 703 between the Authentication Server 17 and the Module 2 which authenticates the Module's TLS Credentials. The Authentication Server 17 may determine token generation data from the Authentication Request 701 including an identifier associated with the Module 2, such as the Module serial number which may be provided within the TLS credentials, and Host related data such as the Host ID, for example from CI Plus Credentials, Module Chip serial numbers and/or the Host's IP address. The token generation data is sent, with a “generate token” request 704, to a Token Server 606.

The Token Server 606 may generate a token using the token generation data, by encrypting or signing the data, for example using HMAC. The Token Server may generate a token that comprises information such as one or more of the Module number, Host ID, Chip serial numbers and the IP address of the Host. In addition, the Token Server may incorporate an expiry date and/or time into the token such that the token is only valid for a specified period of time.

The token is then passed from the Token Server 606 to the Module 2 at steps 705 to 706. This may be via the Authentication Server 17, and then from the Authentication Server back to the Module 2 as shown, or via other routes such as directly to the Module or directly to the Host. The Module may receive the token and passes it to the Host such that it can be utilized by the interactive application. This can be achieved by inserting the token into a carousel as mentioned above, using the Carousel Streamer 608, which is then transmitted to the host at step 707 using an encrypted transport stream, such as an AES encrypted transport stream. The Interactive Middleware Application executing on Host 1 receives the carousel and reads the token from it.

The Interactive Middleware Application may embed the token in a content request URL 708 sent to a Content Server 609 which takes part in the verification of the token and determining the access rights associated with the Module 2. The token may, for example, be sent to the Content Server as part of a content URL using HTTPS to prevent the Session Token from being intercepted in the network. The Content Server 609 extracts the token from the URL and verifies 709 the token using the Token Server 606. In particular, the Token Server may extract data such as the Module serial number, and decrypt the token data using the Token Signing Secret 607 to check that the token has not expired.

If the checks performed by the Token Server confirm that the token is authentic then the provision of content to the host can continue. As an example, the Content Server 609 can acquire entitlements associated with the Module 2 from a user database. The access rights may be associated with module identification data, such as the Module ID. The Content Server may receive appropriate content access keys, or directions to obtain the content keys from a further source. The content keys are then delivered to the Host, possibly using HTTPS to protect content keys being intercepted on the network, and the Host may then be redirected to request content from a Content Distribution Network or further source.

It is possible for the functionalities of the Token Server 606 and the Authentication Server 17 to be implemented within a common server, separate servers or virtual servers. The Token Server and the Authentication Server may be implemented on the same hardware device, with the Token Server and the Authentication Server being different functional modules, or software modules, operating on a particular server device. The Content Server 609 may likewise be included or combined with one or more of the Authentication Server and the Token Server

It should be noted that, in all embodiments of the invention, the Authentication Module 2 may be provided with a communication module for communicating with the Authentication Server. This could be in the form of a wired or wireless (e.g., Wi-Fi, 3G, 4G, etc.) connection to the internet to allow the Authentication Module to communicate directly with the Authentication Server without requiring the routing of data through the host device, negating the need to use an LSC or other communication module in the Host for this purpose. The Module may include an HTTP stack to allow communication via http or http(s) for example. Upon confirmation of authentication, the Authentication Server may issue a temporary “session token” to the host, either over a connection to the host, such as the connection to an LSC or to the Interactive Application via the HTTP stack, or using the connection to the Authentication Module which then forwards the request to the Host in one of the manners described herein. Therefore, in some embodiments the “session token”, or similar, could be issued via the Module using the Application MMI, or over a connection to the Host. The Interactive Middleware Application can then make requests for content or a particular service.

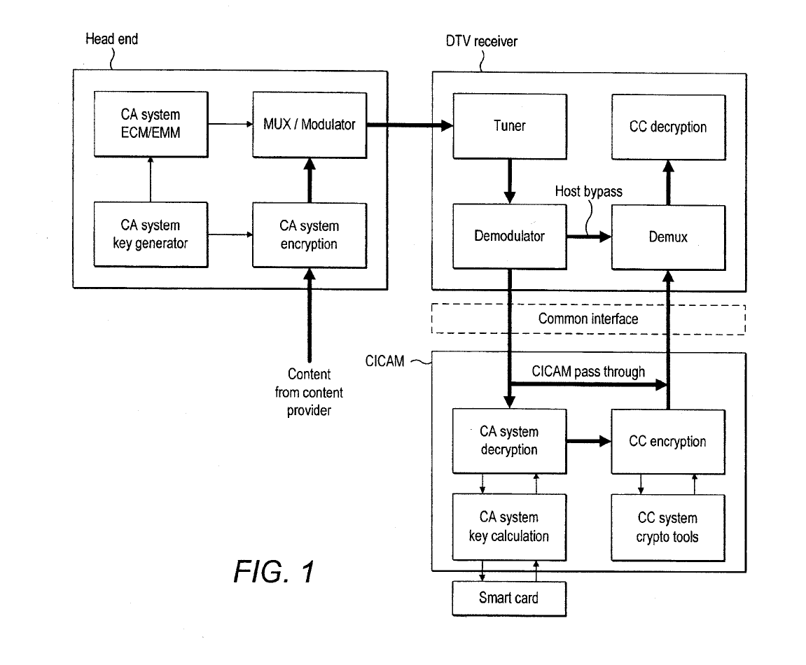

It should be noted that the Authentication Module 2 may be any module with the functionality to provide the authentication required, and particularly, in the example embodiments, operating according to the CI-Plus standard. The Authentication Module may be a Conditional Access Module (CAM) of the sort shown in FIG. 1 or it may be a dedicated module, being a module dedicated to providing mutual authentication with the Host according to the CI-Plus standard and to allow, in some embodiments, Interactive Applications executing on the Host to request files and issue files in the manner described above. The Module may also be any module that combines this basic functionality with any additional functionality.

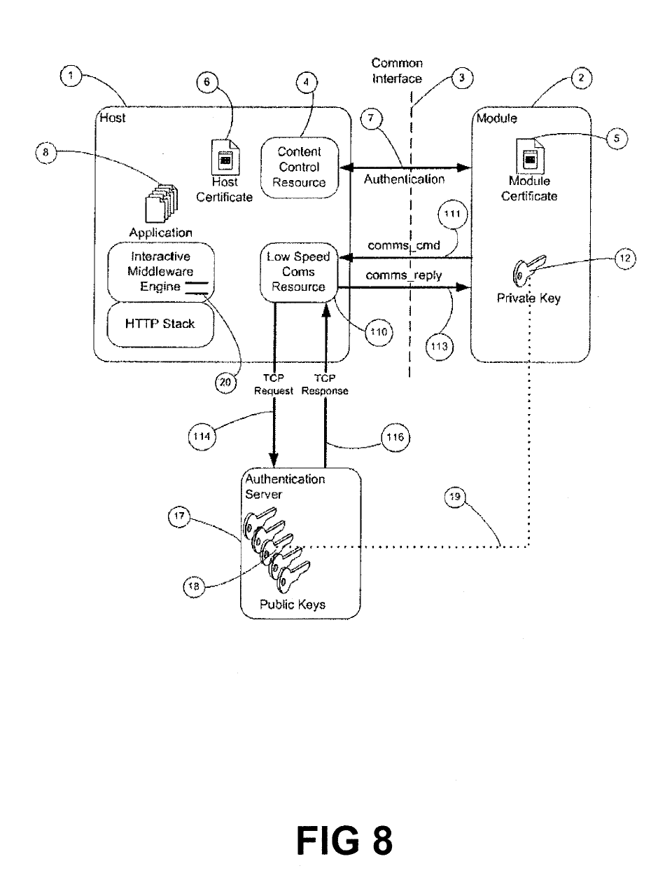

FIG. 8 shows another embodiment of the disclosed technology. It is similar in almost all respects to the embodiment of FIG. 4 and like features to those of FIG. 4 have like references. The additional feature, over the arrangement of FIG. 4, is that the Interactive Middleware Engine 8 of the host device 1 includes a store in the form of a persistent store 20. The persistent store allows the Interactive Middleware Application 8 to store the signed authentication data for retrieval by other Interactive Middleware Applications. The persistent store is non-volatile storage or memory, for example a hard disk drive or flash memory. In the persistent store, data is available beyond the lifecycle of the Interactive Middleware Application 8.

In the example of FIG. 8, once authenticated, the module 2 may initiate or launch an interactive application which writes a signed authentication result or data to the persistent store 20, such that it may be read by or is available to other broadcast applications (interactive applications delivered via broadcast). These other or subsequent broadcast applications read the signed authentication result stored in the store and authenticate the host device 1 by sending the signed authentication data to the Authentication Server 17 requesting that this signature is verified by the Authentication Server.

In other words, in the example of FIG. 8, an interactive application causes the storing of the signed authentication data in the persistent store 20. An interactive application reads the store to acquire signed authentication data. An interactive application sends the signed authentication data to the Authentication Server 17 to verify the signature was created by the Authentication Module 2. The interactive applications are stored on the authentication module 2 and may be delivered via a broadcast.

Thus, in this example, authentication of the Authentication Module 2 by the Authentication Server 17 may includes the following. Authentication may include digitally signing authentication data at the Authentication Module and sending the signed authentication data from the Authentication Module to the host device 1. Authentication may include sending the signed authentication data from the host to the Authentication Server over the low speed communication resource 110 to verify the signature created by the Authentication Module. Authentication may include launching an interactive application stored on the module which writes signed authentication data to the host device's persistent store. Authentication may include a broadcast application reading the signed authentication data from the host device's persistent store 20. Authentication may include a broadcast application sending the signed authentication data to the Authentication Server to verify the signature was created by the Authentication Module. Such a store may be used in the other embodiments of the invention.

Described above are a number of embodiments that detail how data can be passed between the Authentication Module and the Host device beyond the initial authentication step, and the nature of the data used for authentication between the Authentication Module and the Authentication Server. There are many possibilities as to how this may be implemented. Four examples are given below, referred to as Carousel Insertion, Common Interface Input Module Resource, Specific Application Support and Host Control Resource respectively.

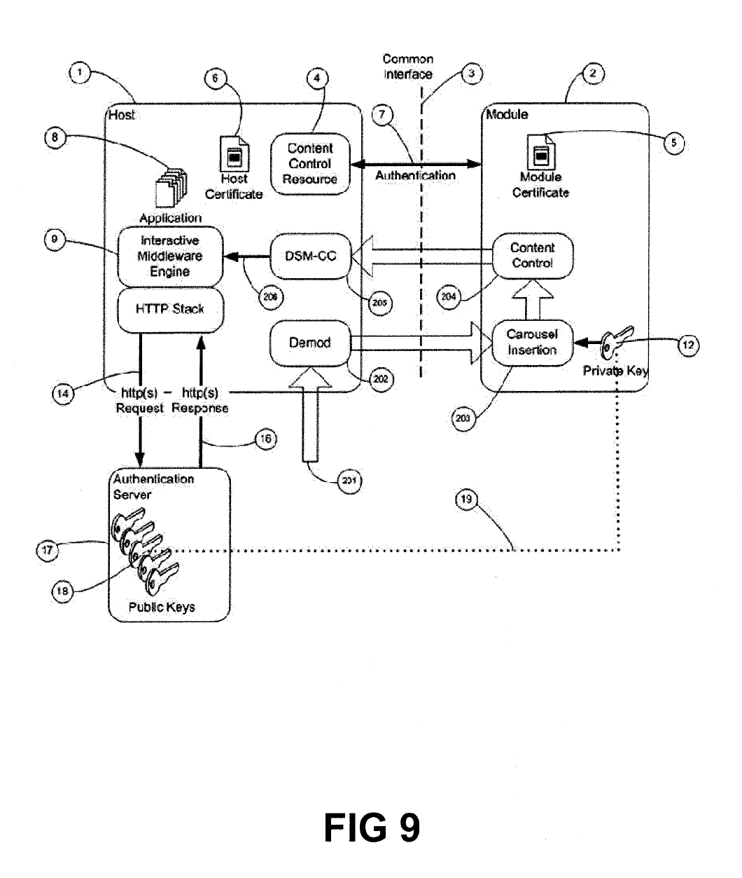

FIG. 9 shows an alternative embodiment of the invention in relation to a system that is similar to that described in relation to FIGS. 2 and 3, although the concepts described in relation to this figure are applicable to other embodiments of the invention. Common components and features with the embodiment of FIGS. 2 and 3 are given like references. The general authentication method as between the Host and the Authentication Module, and between the Authentication Module and the Authentication Server, may be the same as that described for the embodiments above. However, the manner in which information is communicated from the Authentication Module to the Host differs. The embodiment of FIG. 9 uses what will be termed “carousel descrambling insertion”, “or carousel insertion”, which has been mentioned in relation to the embodiment of FIG. 6 and will be described below in more detail.

The DVB CI specification EN 50221, mentioned above, defines how scrambled Broadcast Transport Stream packets may be sent from the Host to the Authentication Module and be descrambled by the Module before being returned to the Host. Broadcast Transport Streams may also include an Object Carousel, such as a digital storage media command and control (DSM-CC) Object Carousel, which provides a standard broadcast file system to deliver files over broadcast, including providing Interactive Applications and files to the Interactive Middleware Engine. An Object Carousel client will be present in the Host device to decode the carousel and present a file system to the Interactive Middleware Engine.

Conventionally, in standards like the CI Plus standard, the Authentication Module descrambles the Transport Stream packets, including the Object Carousel, and provides these back to the Host. In the embodiment shown in FIG. 9, however, instead of descrambling the Transport Stream packets, the Authentication Module replaces the relevant Transport Stream packets with those of a different Object Carousel delivered from the Authentication Module. That is, the Authentication Module inserts into the Transport Stream an alternative Object Carousel to that provided in the broadcast Transport Stream, assuming that there is an Object Carousel within the received Transport Stream. If there is no Object Carousel within the received Transport Stream then one can be inserted by the module.

The Object Carousel, inserted into the broadcast file system, may contain a generic Interactive Application and file, or files, unique to the Authentication Module. For example a file inserted in the broadcast file system may contain data signed by the Authentication Module's Private Key. Files unique to the Authentication Module may be read from the broadcast file system by the Interactive Application and sent to the Authentication Server such that it may authenticate the Module and thus authenticate the Host device according to the methods described above. The data/files inserted into the Transport Stream may include metadata identifying the Authentication Module, in the same manner as described above.

The Authentication Module may additionally, or alternatively, communicate with the Authentication Server over the low speed communications resource described in relation to FIGS. 4 and 5. This allows the Authentication Server to provide the authentication data, which the Authentication Module then signs, passes to the application using the above mentioned carousel insertion technique, and is then returned to the Authentication Server by the Interactive Application.

In the authentication system of FIG. 9, the Host device 1 is configured to perform mutual authentication with the Authentication Module 2 according to the same methods described above. The primary difference over the embodiments of FIGS. 2 and 3 is the manner in which subsequent authentication between the Authentication Module 2 and the Authentication Server 17 takes place.

In the embodiment of FIG. 9, the Host receives a broadcast transport stream 201 and routes this via the Module 2, as defined, for example, in the Digital Video Broadcast (DVB) Common Interface (CI) specifications EN 50221. The usual purpose of routing the transport stream via the Module is to descramble the transport packets and return them to the Host. However, in this arrangement, rather than descramble the transport packets, or as well as doing this, a resource or functional module referred to as Carousel Insertion 203 replaces transport packets of the incoming transport stream with new transport packets constructed on, or received by, the Authentication Module. The Carousel Insertion functional module could be an application or program executing on the Authentication Module or a combination of an application, which creates or selects the packets to insert, and a module hardware function which inserts the packets. The Carousel Insertion module may, for example, be implemented within a Carousel Streamer as described in relation to FIG. 6. The inserted transport packets provide an Object Carousel, such as a DSM-CC Object Carousel, which is passed back to the Host and decoded by an appropriate client such as DSM-CC Client 205. The client provides a broadcast file system to the Interactive Middleware Engine 9, such that the Interactive Application 8 may read files 206 from the Object Carousel.

The Object Carousel which is inserted by this mechanism may be constructed on the Authentication Module 2 and includes a file or files which have been signed by the Authentication Module's Private Key 12. The Interactive Application reads the signed file or files and sends them to the Authentication Server 17, for example as part of a request for authentication. The Authentication Server then verifies the data has been signed by a known and trusted Authentication Module according to any of the methods described herein.

The data which is signed by the Authentication Module and inserted in the Object Carousel may be provided to the Authentication Module over a Low Speed Communication resource, or extracted from the broadcast Transport Stream, or may be provided by some other means.

Optionally, the Content Control resource 204, which is provided as part of the CI Plus standard, may be used to scramble the inserted transport packets before they are sent back from the Authentication Module to the Host, such that they cannot be detected or modified as they pass across the Common Interface. This prevents an eavesdropping style attack that may be used to identify and exploit the added Object Carousel data. The Content Control resource is a functional unit that can be implemented as an application or program executing on the Authentication Module, or as a combination of software and hardware functions for example.

As described in relation to FIG. 6, this Carousel Insertion technique may also or instead be used to pass tokens issued by a token server from the Module to the Host.

An alternative to the embodiment of FIG. 9 may make use of what is known as the “Common Interface Input Module Resource” to deliver a Transport Stream to the Host device, as defined by the CI standard. The Common Interface Input Module Resource is a system resource, as defined in the above mentioned standards, that allows a compliant system to receive additional content, for example in the form of additional Transport Streams, delivered by means other than the main broadcast to the Host device. Input modules may be simple, potentially low-cost modules for delivery of broadcast services via, for example, DVB-C, DVB-S or DVB-T networks to Hosts. Input modules may also allow other types of services and networks to be delivered. The Common Interface Input Module Resource ensures that the Host and Authentication Module handle data from the input module correctly.

In this embodiment, the device authentication methods used may be identical to the Carousel Insertion method described in relation to FIG. 9, except there is no broadcast Transport Stream delivered from the Host to the Authentication Module. Instead the Authentication Module can be configured to function as an Input Module, operating in the CI Plus Input Module operating mode, which allows the Authentication Module to be the source of the Transport Stream, as far as the Host is concerned, and the Transport Stream is then delivered to the Host. In relation to FIG. 9, rather than using a demodulated broadcast stream received by the Host as a source that is provided to a Carousel Insertion resource, the source could be provided to the Authentication Module via some other broadcast means, via the internet, or even generated on the Authentication Module itself, for example being built up from received data files. The transport stream can then have the object carousel with authentication data inserted into it by the Module, in the same manner as described in relation to FIG. 9. Alternatively the transport stream can be created by the Module with the required object carousel containing the authentication data, such that the Module then delivers the entire Transport Stream to the Host rather than inserting a carousel into an existing stream. The Carousel Insertion block may therefore not be required.

Certain embodiments described above have described a CI-Plus Application MMI Resource communicating with the Interactive Middleware Engine. The CI Plus standard also defines a resource that is similar in nature to the Application MMI, the Specific Application Support (SAS). This resource is similar to the one defined in the OpenCable specifications, CableCARD Interface 2.0 specification OC_SP_CCIF2.0-I23-110512. The SAS Resource offers a transparent pipe that allows an application on the Host to access functionality on the CICAM.

An alternate embodiment of the invention could use the SAS Resource. The SAS Resource is similar in nature to the Application MMI in that it allows an Interactive Application to send data/files to and receive data/files from the Authentication Module. Device Authentication would happen in the same way as the Application MMI embodiment, except that it would require the use of a Hybrid Broadcast Broadband TV (HbbTV) application, or a Multimedia Home Platform (MHP, or DVB-MHP) application, as these can access the SAS resource, whereas MHEG applications cannot. The HbbTV application is another interactive middleware application, as with the MHEG applications, but is typically used in Europe whereas MHEG applications are typically used in the UK.

A further alternate embodiment of the invention could use the Host Control Resource. The Host Control Resource was revised in the DVB CI Plus standard to version 2. Host Control version 2 adds new commands allowing for the CICAM to tune the Host to a service which is not part of the Host channel line-up. The service selected is based on the physical description of the Transport Stream that carries the service and the service identification.

The Host Control Resource allows the Authentication Module to re-tune the Host to a DVB service and in doing so, pass a Program Map Table (PMT) to be used to decode the service. The PMT contains PID numbers of elementary streams associated with the program and contains information about the type of these elementary streams (video, audio, text, etc.), as well as details on how to decode the streams.

This embodiment can utilize the Host Control Resource to pass a PMT generated by the Authentication Module to the Host. The PMT may be used to contain data within one of the descriptor fields within the PMT, to be used in the authentication process with the Authentication Server, which can be referred to generally as authentication data. The Host executes an application that can read the data contained in the relevant descriptor field. As described above, the authentication process may include using arbitrary data that is signed by the Authentication Module using a private key and passed to the Authentication Server to determine whether the Module is indeed authentic, or it may include any other suitable authentication methods.

The DTG DBook standard, as described in the DTG DBook 7, defines the “GetBootInfo” resident program along with the data_broadcast_id descriptor and the network_boot sub descriptor. These features are also described in the European Telecommunications Standards Institute MHEG standard, such as the ETSIMHEG document ES 202184 v2.2.1. The GetBootInfo resident program can read the value of the network boot info field in the network boot sub descriptor. The network_boot_info sub-descriptor provides a method by which a network operator may signal a running application to perform a specified action. This signal is provided in the data_broadcast_id descriptor so as to become independent of the data broadcast itself.

The data_broadcast_id descriptor is carried in the PMT and identifies the auto boot PID of a broadcast carousel. The GetBootInfo resident program can be used by an MHEG application to access the network boot info carried in the network_boot sub descriptor, which is contained within the data_broadcast_id descriptor. Authentication data, which has been processed by the Authentication Module, can be passed to the Host by placing it in the network_boot sub descriptor of a PMT generated or received by the Authentication Module. In particular, authentication may be achieved by the Authentication Module signing some arbitrary data with the Module's Private Key, placing the signed data in the network_boot sub descriptor of a PMT generated or received by the Authentication Module, and passing this to the Host Control Resource Tune request. An MHEG application launched on the target service could read the signed data and send it to the Authentication Server, which verifies the data has been signed by a known and trusted Authentication Module and in doing so also authenticates the Host device, as described above.

Embodiments of the invention have been described in relation to the CI Plus standard, involving applications such as MHEG applications, HbbTV applications or MHP applications, running on a host device. The particular aspect of the CI Plus standard that is used in the embodiments is the mutual authentication between the remote module and the host device, such as the mutual authentication described in version 1.3.1 of the CI Plus standard specification. Embodiments of the invention may be implemented with any appropriate communication protocol between a removable module and host device that provides mutual authentication between the host device and the module, allowing authentication of the Module with an Application Server such that the Application Server is able to trust the Host device into which the removable Module is inserted. Alternative communication protocols or standards that would be appropriate include the CableCARD standard, referring to a set of technologies allowing devices to access other cable company networks. The CableCARD standard may rely upon a special PCMCIA card allowing consumers to view and record digital cable television channels on devices such as digital video recorders, personal computers and television sets without requiring specialized equipment such as a set top box provided by a content providing company. Other appropriate standards possessing the necessary properties are possible.

Embodiments of the invention involve performing authentication of the Authentication Module in response to a request of some sort issued to the Authentication Server, by the Authentication Module or the Host. The issuance of a separate request may not be necessary, since sending authentication data to the Authentication Server could itself be considered to be a request to authenticate. The authentication by the server may not necessarily, therefore, strictly speaking follow a separate request.

Embodiments of the invention have described television receiver systems that receive content via broadcast and also via the internet. The term “broadcast” is intended to cover the delivery of content in a broadcast using any suitable method such as over the air, via satellite or using cable.

What is claimed is:

1. A method for authenticating a host device in a television receiver system for providing media content to a user, wherein the system comprises:
a host device to be authenticated, the host device being configured to receive media content via broadcast and/or via the internet; and
a removable authentication module coupled to the host by an interface, the host and authentication module being configured to communicate over the interface and to perform mutual authentication of the host device and authentication module according to a particular protocol;
wherein at least one of the host device and the removable authentication module are configured to communicate with an authentication server;
the method comprising:
issuing a request to the authentication server to perform authentication of the authentication module;
performing authentication of the authentication module by exchanging data between the authentication server and the authentication module;
wherein the host device is deemed to be authenticated when the authentication module and host are successfully mutually authenticated and the authentication module is successfully authenticated by the authentication server.

2. A method according to claim 1 wherein the host and authentication module are coupled, and communicate, according to the Common Interface (CI) Plus standard, the mutual authentication of the host device and authentication device being performed in accordance with the CI-Plus standard, wherein authentication of the authentication module by the Authentication server verifies that the host is compliant with the CI-Plus standard.

3. A method according to claim 2 wherein the CI-Plus standard is as defined in CI Plus Specification v1.3.1 (2011-09).

4. A method according to claim 1, 2 or 3 wherein the host device is configured to execute an application configured to request data from a server, the authentication of the host device allowing the data request to be granted, the application being an MHEG application.

5. A method according to claim 4 wherein the interactive application is configured to provide media content to a user using an MHEG interaction channel.

6. A method according to claim 4 or 5 wherein an Application Man Machine Interface resource is used to send and receive data between the host and the authentication module.

7. A method according to claim 4, 5 or 6 wherein the interactive application communicates with the authentication module via an API.

8. A method according to any preceding claim wherein the host device is configured to communicate with the authentication server, and wherein performing authentication of the authentication module comprises exchanging data between the authentication server and the authentication module via the host device.

9. A method according to claim 8 wherein data is exchanged between the authentication server and the authentication module using cryptographic techniques such as TLS.

10. A method according to claim 9 wherein authentication of the authentication module by the authentication server comprises:
receiving authentication data at the host;
sending the authentication data from the host to the authentication module;
digitally signing the authentication data at the authentication module and sending the signed authentication data from the authentication module to the host; and
sending the signed authentication data from the host to the authentication server to verify the signature created by the authentication module.

11. A method according to any preceding claim wherein authentication of the authentication module by the authentication server is performed using a communication resource located on the host, such as a low speed communication resource.

12. A method according to claim 11 wherein authentication of the authentication module by the authentication server comprises:
digitally signing authentication data at the authentication module and sending the signed authentication data from the authentication module to the host;
sending the signed authentication data from the host to the authentication server over the communication resource to verify the signature created by the authentication module.

13. A method according to claim 12 wherein authentication of the authentication module by the authentication server is performed using TLS.

14. A method according to any preceding claim wherein data is passed from the authentication module to the host using a component of the transport stream.

15. A method according to claim 14 wherein data is passed from the authentication module to the host using an object carousel.

16. A method according to claim 15 wherein the method further comprises inserting the data into an existing object carousel, generating the object carousel containing the data at the authentication module or receiving the object carousel containing the data at the authentication module from a remote source.

17. A method according to claim 16 wherein the method further comprises receiving a transport stream at the authentication module, via the host, and inserting the object carousel into the transport stream.

18. A method according to any of claims 14 to 17 wherein the host executes an application to read the data from a component of the transport stream.

19. A method according to claim 18 wherein the host executes an application to read the data from the object carousel in the transport stream.

20. A method according to any of claims 14 to 19 wherein the data is a token confirming access rights to content.

21. A method according to any of claims 14 to 19 wherein the data is authentication data for use in authentication of the module.

22. A method according to any of claims 14 to 21 wherein the transport stream is scrambled, encrypted or encoded by the module before being passed to the host and descrambled, decrypted or de-encoded.

23. A computer program which when executed on a host device and/or authentication module causes it to carry out the method of any preceding claim.

24. A television receiver system for use in authenticating a host device, the system comprising:
a host device to be authenticated, the host device being configured to receive media content via broadcast and/or via the internet; and
a removable authentication module coupled to the host by an interface, the host and authentication module being configured to communicate over the interface and to perform mutual authentication over the interface according to a particular protocol;
wherein
at least one of the host device and the removable authentication module further comprise a communication module configured to communicate with an authentication server;
and wherein
the system is configured to issue a request to the authentication server, using the communication module, to perform authentication of the authentication module, in response to which authentication of the authentication module is performed by the authentication server; and
the host device is deemed to be authenticated when the authentication module and host are successfully mutually authenticated and the authentication module is successfully authenticated by the authentication server.

25. A system according to claim 24 wherein the communication module is located in the host device, and wherein performing authentication of the authentication module comprises exchanging data between the authentication server and the authentication module via the host device using secure communication techniques such as TLS.

26. A system according to any of claim 24 or 25 wherein the communication module comprises a communication resource, such as a low speed communication resource, located on the host device.

27. A system according to claim 26 wherein the system is configured to authenticate the authentication using TLS by:
digitally signing authentication data at the authentication module and sending the signed authentication data from the authentication module to the host; and
sending the signed authentication data from the host to the authentication server over the communication resource to verify the signature created by the authentication module.

28. A system according to any of claims 24 to 27 wherein the authentication module is configured to pass data to the host using an object carousel.

29. A system according to claim 28 wherein the authentication module is configured to insert the data into an existing object carousel, to generate the object carousel containing the data or to receive the object carousel containing the data at the authentication module from a remote source.

30. A system according to claim 29 wherein the authentication module is configured to receive a transport stream, via the host, and to insert the object carousel into the transport stream.

31. A system according to any of claims 28 to 30 wherein the host is configured to execute an application to read the data from the transport stream.

32. A system according to any of claims 24 to 31 wherein the authentication module is a conditional access module.

33. A host device (1) for use in a method according to any of claims 1 to 22 or in a television receiver system according to any of claims 24 to 32, the host device being configured to receive media content via broadcast and/or via the internet, the host device having a communication module to communicate with an authentication server;
the host device further comprising an interface for communication with a removable authentication module, the host being configured to communicate with the authentication module over the interface and to perform mutual authentication over the interface according to a particular protocol;
wherein
the host is configured to issue a request to the authentication server, using the communication module, to perform authentication of the authentication module, in response to which authentication of the authentication module is performed by the authentication server via the host device; and
the host device is deemed to be authenticated when the authentication module and host are successfully mutually authenticated and the authentication module is successfully authenticated by the authentication server.

34. An authentication module configured for use in a method according to any of claims 1 to 22, or a system according to any of claims 24 to 32, the authentication module comprising:
an interface for communication with a host device, the module being configured to communicate with the host device over the interface and to perform mutual authentication over the interface according to a particular protocol; and
a memory having stored thereon module specific credentials, and wherein the authentication module is configured to digitally sign authentication data using the module specific credentials to perform authentication of the authentication module by a remote authentication server.

35. An authentication server for use in a method according to any of claims 1 to 22 or with a system according to any of claims 24 to 32, the authentication server being configured to perform authentication of the authentication module by receiving a digital signature from the authentication module and authenticating the digital signature, wherein the host device is deemed to be authenticated when the authentication module and host are successfully mutually authenticated and the authentication module is successfully authenticated by the authentication server, wherein the authentication server is further configured, upon successful authentication of the authentication module, to issue a communication, such as a token, to the host enabling the host to perform a further function.
